(19) United States
(12) Patent Application Publication
(10) Pub. No.: US 2015/0349608 A1
(43) Pub. Date: Dec. 3, 2015

(54) Axial Gap Motor

(71) Applicant: Hitachi, Ltd., Tokyo (JP)

(72) Inventors: Yoshitsugu TSUTSUMI, Tokyo (JP); Kenta DEGUCHI, Tokyo (JP); Akihito NAKAHARA, Tokyo (JP); Satoshi KIKUCHI, Tokyo (JP)

(21) Appl. No.: 14/722,288

(22) Filed: May 27, 2015

(30) Foreign Application Priority Data
May 28, 2014 (JP) 2014-109662

(51) Int. Cl. H02K 9/00; H02K 1/27

(52) U.S. Cl. CPC H02K 9/005; H02K 1/2793

(57) ABSTRACT

Provided is an axial gap motor provided with a rotor fixed to a rotary shaft, a stator facing the rotor along a shaft direction, a flow passage forming body that forms a flow passage through which a cooling refrigerant is flowed, and a housing that houses the rotor and the stator and that holds the flow passage forming body. The flow passage forming body forms an inflow port provided on a first surface of the housing facing the shaft direction, a flow passage portion passing from the inflow port through a lateral portion of the rotor in a radial direction, and a discharge port connected to the flow passage portion and provided closer to the stator than the rotor in the shaft direction.

### BACKGROUND OF THE INVENTION

1. Field of the Invention

The present invention relates to an axial gap motor.

2. Description of the Related Art

An axial gap motor is constituted of a discoidal rotor and a stator arranged so as to face the rotor. The rotor has a plurality of tabular permanent magnets arranged in a circumferential direction, and the stator has a plurality of electromagnets, each constituted of a core and a coil, arranged in the circumferential. direction. The rotor is attached to a shaft. The shaft is supported by a bearing, which is attached to an end bracket. The stator is held by a housing on an outer periphery side. The housing is bonded to the end bracket. In a case of a totally enclosed type axial gap motor, it is covered in all directions by the housing and the end bracket.

The axial gap motor has a two-rotor one-stator configuration in which both sides of the stator are sandwiched by two rotors for increasing torque per volume and a gap surface is formed on the both sides of the stator.

In the axial gap motor, most of loss occurs in the coil and the core, which constitute the electromagnet. The loss causes heat, which is conducted to the core, a core support member, and the housing being in contact therewith by heat conduction, and the heat is eventually radiated to outside air. As a different channel, the heat is conducted from the stator to the rotor by heat transfer of gas inside. The heat that has been conducted to the rotor and the shaft is conducted to the bearing and the end bracket by the heat conduction, and a part thereof is conducted to the housing by the heat transfer and is eventually radiated to the outside air. A temperature of the stator and the rotor is increased by the heat that has not been radiated. As a temperature of the magnet of the rotor is increased, magnetic force thereof is decreased, and efficiency of the axial gap motor is decreased.

In a case where the axial gap motor is mounted, for example, on a hybrid vehicle, large torque is necessary. As the torque is increased, electric current flowed in the coil is also increased, whereby the heat generated in the coil and the core is increased. Accordingly, cooling of the axial gap motor cannot be performed sufficiently only by cooling through radiation of the heat from the housing to a surrounding air by the conventional heat conduction.

Therefore, it is necessary to suppress temperature rise by supplying coolant to the stator directly and facilitating the cooling by the heat transfer of the coolant. However, although depending on the number of rotations of the rotor as well as a diameter of the rotor, an airflow of tens of m/s is generated when the axial gap motor is rotating. Simply supplying a cooling refrigerant may not work because the supplied coolant may be scattered by the airflow and may not be supplied to a place desired to be cooled.

In JP 2012-253899 A, there is described an axial type rotary electric machine in which coolant is used for cooling the stator thereof, and cooling is performed by supplying the coolant to the rotor and the stator through a coolant supply pipe penetrating a housing.

### SUMMARY OF THE INVENTION

A cooling method in JP 2012-253899 A has the following problem. In a case where the rotor is rotated at a high speed, since the coolant to be supplied to the stator is supplied to a surface facing the rotor, the coolant is scattered due to an influence of the airflow generated by the rotor, whereby it is not possible to appropriately supply the coolant to a place to be cooled of the stator. Furthermore, since the coolant for cooling the rotor is supplied being jetted toward a side surface of the rotor, it is scattered due to the airflow generated by the rotor. Accordingly, cooling performance of the stator and the rotor is decreased.

The problem to be solved by the present invention is to improve refrigerant performance of the axial gap motor.

Features of the present invention for solving the above-described problem are, for example, as below.

The axial gap motor is provided with a rotor fixed to a rotary shaft, a stator facing the rotor along a shaft direction, a flow passage forming body configured to form a flow passage through which the cooling refrigerant is flowed, and a housing configured to house the rotor and the stator and to hold the flow passage forming body. The flow passage forming body forms an inflow port provided on a first surface of the housing facing the shaft direction, a flow passage portion passing from the inflow port through a lateral portion of the rotor in a radial direction, and a discharge port connected to the flow passage portion and provided closer to the stator than the rotor in the shaft direction.

According to the present invention, it is possible to improve the refrigerant performance of the axial gap motor. A problem, a configuration, and an effect other than those described above are clarified in descriptions of embodiments below.

### BRIEF DESCRIPTION OF THE DRAWINGS

FIG. 1 is an external appearance view of an axial gap motor according to one embodiment of the present invention;

FIG. 2 is a sectional view of a plane A in FIG. 1 viewed from an arrow direction;

FIG. 3 is a perspective view of a coolant supply pipe provided to an end bracket;

FIG. 4 is a sectional view of the coolant supply pipe according to one embodiment of the present invention;

FIG. 5 is a sectional view of the coolant supply pipe according to one embodiment of the present invention; and

FIG. 6 is an exploded perspective view of the axial gap motor according to one embodiment of the present invention.

### DESCRIPTION OF THE PREFERRED EMBODIMENTS

Hereinafter, an embodiment of the present invention is described by using the drawings and the like. The descriptions below describe a specific example of a content of the present invention, whereby the present invention is not to be limited to these descriptions, and various changes and rectifications are possible by those skilled in the art within a scope of technical concept disclosed herein. In all of the drawings illustrating the present invention, component having the same function is denoted with the same reference numeral, and a repeated description thereof may be omitted.

### First Example

In this embodiment, a configuration is used in which a flow passage forming body forms an inflow port provided on a first surface of a housing facing a shaft direction, a flow passage portion passing from the inflow port through a lateral portion of a rotor in a radial direction, and a discharge port connected to the flow passage portion and provided closer to a stator than the rotor in the shaft direction.

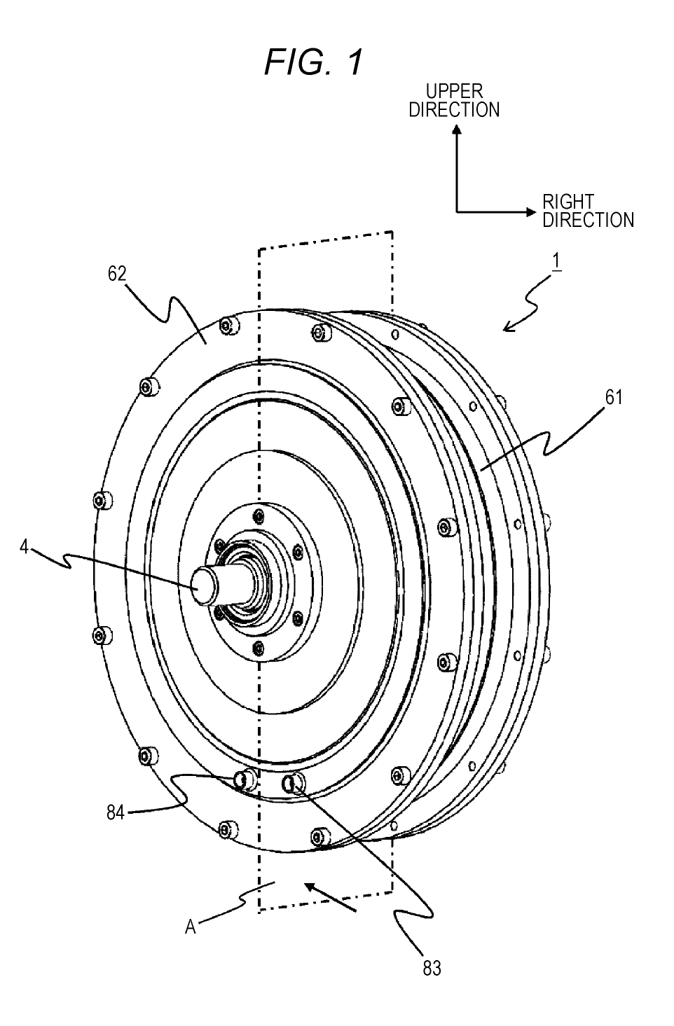

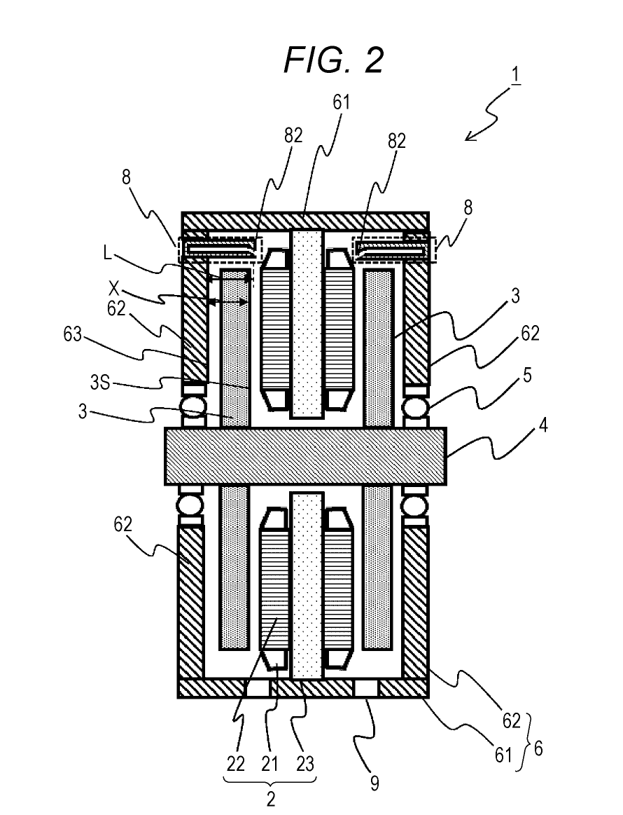

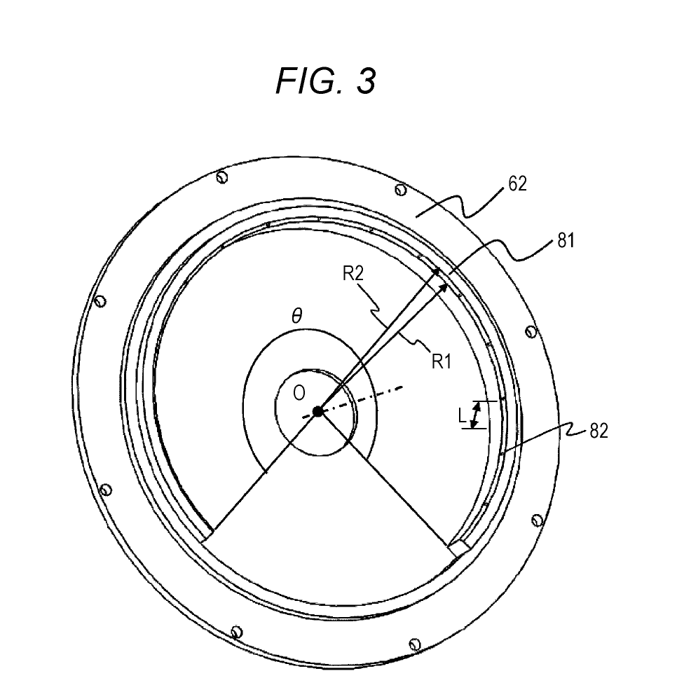

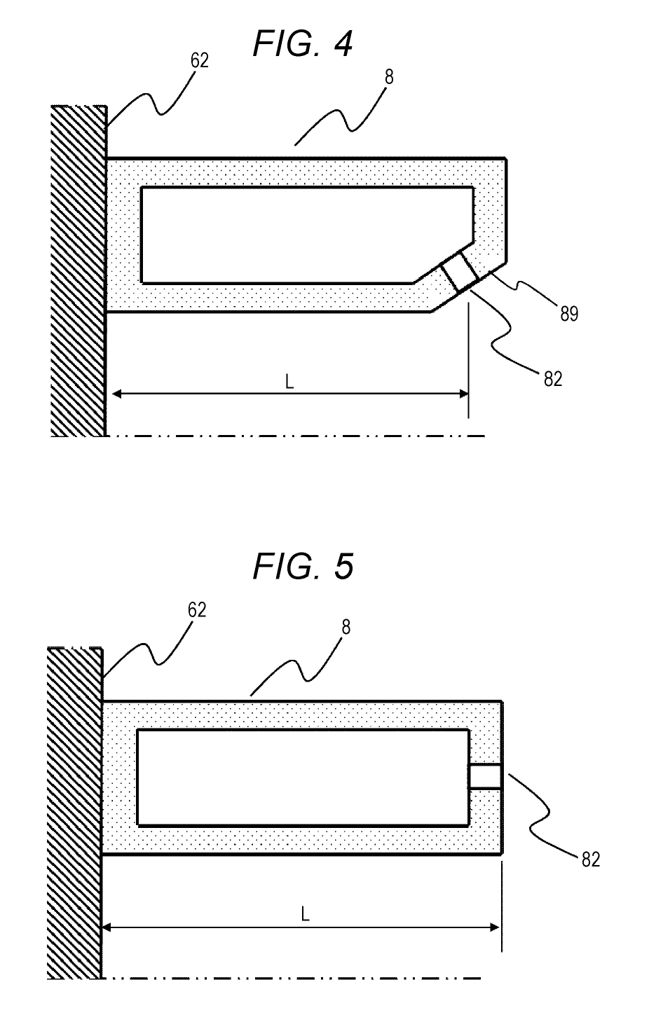

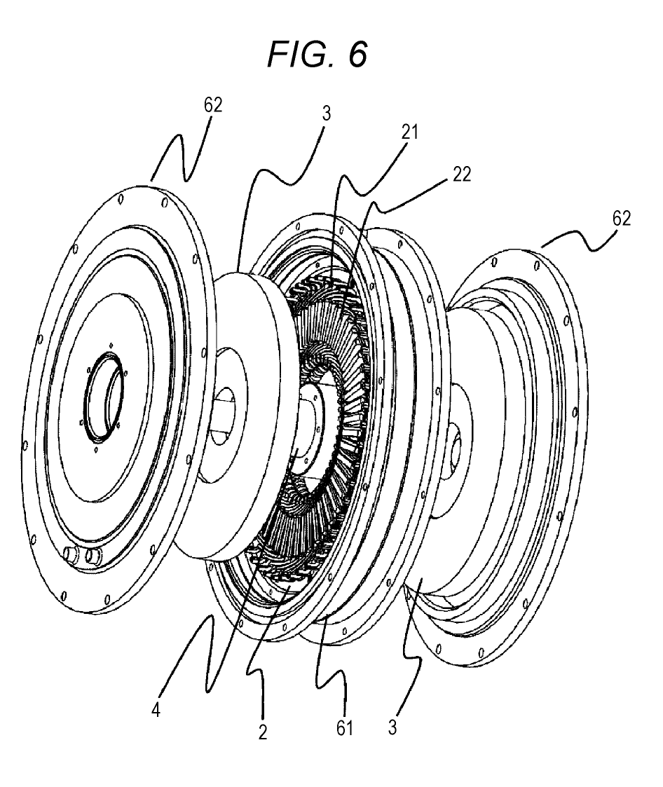

A first example is described by using FIGS. 1 to 4 and FIG. 6. FIG. 1 is an external appearance view of an axial gap motor according to this embodiment. FIG. 2 is a sectional view of a plane A in FIG. 1 viewed from an arrow direction. FIG. 3 is a perspective view of a coolant supply pipe provided to an end bracket. FIG. 4 is a sectional view of the coolant supply pipe. FIG. 6 is an exploded perspective view of the axial gap motor according to this embodiment. Note that as denoted with arrow marks in FIG. 1, an upper side in the drawing represents an upper direction, and a right side in the drawing represents a right direction.

The axial gap motor in FIG. 1 is of a one-stator two-rotor type. A rotor 3 is constituted of a first rotor and a second rotor, which are arranged facing the shaft direction and sandwiching a stator 2. The stator 2 is constituted of a core 22, a support member 23 supporting the core 22, a first coil arranged on a lateral side of the support member 23 on a side close to the first rotor relative to the shaft direction, and a second coil arranged on a lateral side of the support member 23 on a side close to the second rotor relative to the shaft direction. The flow passage portion is constituted of a first flow passage portion passing through a lateral portion of the first rotor in a radial direction and a second flow passage portion passing through a lateral portion of the second rotor in a radial direction. The discharge port is constituted of a first discharge port, which is connected to the first flow passage portion and provided closer to the first coil than the first rotor in a shaft direction, and a second discharge port, which is connected to the second flow passage portion and provided closer to the second coil than the second rotor in the shaft direction.

An axial gap motor 1 of this embodiment, as illustrated in FIG. 2, is constituted of the discoidal rotor 3, the stator 2 facing the rotor 3 though a gap, a shaft 4 connected to the rotor 3 on an inner periphery of the rotor 3, a bearing 5 supporting the shaft 4, an end bracket 62 to which the bearing 5 is attached, and a housing 61 connected to the end bracket 62 and an outer periphery of the stator 2. A chassis 6 is constituted of the cylindrical housing 61, which houses the stator 2 and the rotor 3 and holds a cooling refrigerant supply pipe 8, and the end bracket 62 attached to both ends of the housing 61.

The rotor 3 is constituted of a non-illustrated magnet as well as a structure material and a back yoke holding the magnet. The rotor 3 is fixed to the shaft 4 (rotary shaft).

The stator 2 is constituted of the core 22, a coil 21 wound therearound, and the support member 23 supporting the core 22. The stator 2 is facing the rotor 3 along the shaft direction. As the coil 21 of the stator 2, a copper wire or an aluminum wire is used. As the core 22, a soft magnetic material such as an electromagnetic steel sheet, lamination of an amorphous foil, or a powder magnetic core is used. As the magnet of the rotor 3, a ferrite magnet, a neodymium magnet, or the like are used.

In this embodiment, as illustrated in FIG. 2, the cooling refrigerant supply pipe 8 (flow passage forming body) is provided in the end bracket 62. The cooling refrigerant supply pipe 8 forms a flow passage through which a cooling refrigerant is flowed. As illustrated in FIG. 1, an inlet and an outlet through which coolant is supplied to the cooling refrigerant supply pipe 8 is illustrated as a coolant supply pipe inlet 83 and a coolant supply pipe outlet 84 on a surface of the end bracket 62. The coolant supply pipe outlet 84 generates jetting force in the shaft direction and jetting force in a vertical direction relative to the shaft direction.

In FIG. 1, the coolant supply pipe inlet 83 is on a right side, and the coolant supply pipe outlet 84 is on a left side; however, there is no problem functionally with disposing them reversely, i.e., disposing the coolant supply pipe inlet 83 on the left side and the coolant supply pipe outlet 84 on the right side. It is possible to select between them as appropriate according to a mounting form of the axial gap motor 1.

As illustrated in FIG. 2, the coolant supply pipe 8 is arranged at the top and substantially on an outer periphery side in a radial direction or the coil 21 of the stator 2. At the bottom of the housing 61, a coolant discharge port 9 for recovering the coolant is provided.

As illustrated in FIG. 3, the coolant supply pipe 8 is formed of a thickness obtained. by subtracting an inner periphery side bend radius R1 of the coolant supply pipe 8 from an outer periphery side bend radius R2 of the coolant supply pipe 8. The coolant supply pipe 8, in a circumferential direction, is formed in an arc shape having an angle θ of an arc of the coolant supply pipe centering on a rotary shaft. In FIG. 3, O denotes an arc center of bending of the coolant supply pipe 8

As illustrated in FIG. 4, in a section of the coolant supply pipe 8, a section of a flow passage space through which the cooling refrigerant passes is a trapezoidal shape. A plurality of coolant supply holes 82 having the same diameter is formed on an inclined surface 89 at substantially equal intervals. It is preferred that the angle of the arc of the coolant supply pipe 8 (denoted with 9 in the drawing) be approximately 180 degrees or greater such that the coolant is supplied. In a horizontal direction (a crosswise direction in the drawing) and that cooling is performed effectively by the coolant supply holes 82.

Operation of the axial gap motor 1 of this example is described. When the coil 21 is conducted using a non-illustrated inverter and a non-illustrated alternating-current power supply, an alternating magnetic field is formed on a surface of the stator 2. By attraction and repulsion between the alternating magnetic field and a static magnetic field of the rotor 3 caused by the magnet, the rotor 3 generates rotor torque. From a non-illustrated coolant. supply system installed outside of the axial gap motor 1, the coolant is supplied through the coolant supply pipe inlet 83 connected to the coolant. supply pipe 8. The coolant supply pipe 8 functions as the flow passage forming body.

A distance L in FIGS. 3 and 4 is a distance from an inner wall surface 63 of the end bracket 62 to the cooling refrigerant supply hole 82 in the shaft direction. A distance X is a distance from the inner wall surface 63 of the end bracket 62 to a surface 3S of the rotor 3 on a side close to the stator 2 in the shaft direction. The cooling refrigerant supply hole 82 is formed in the coolant supply pipe 8 such that the distance L is greater than the distance X. The cooling refrigerant supply hole 82 functions as a discharge port of the cooling refrigerant,

In this way, since the coolant supply pipe 8 is formed across a space on a lateral portion of the rotor 3 in the radial direction and the cooling refrigerant supply hole 82 is provided closer to the stator than the rotor in the shaft direction, the cooling refrigerant can be jetted. toward the stator 2 from the cooling refrigerant supply hole 82 without being influenced by an airflow generated by the rotor 3, and it is possible to improve cooling performance.

In this example, as illustrated in FIG. 4, the coolant supply holes 82 are open on an inclined surface of a coolant supply pipe 81 at a right angle, whereby the coolant is jetted in the shaft direction and a direction orthogonal thereto, i.e., at an angle of approximately 45 degrees. The jetted coolant is supplied to the coil 21 and the core 22 as well as to the support member 23 of the stator 2 by a flow. Subsequently, a part of the supplied coolant is dropped on the shaft 4 and performs cooling of the shaft 4.

By centrifugal force generated by rotation of the shaft 4, the coolant is transported to the coil 21 and the core 22 at another position in the stator 2 and cools another portion of the stator 2. The other part of the coolant is supplied to the other portion of the stator 2 through the coil 21 and cools the coil 21 and the core 22 at the other position in the stator 2.

A part of the coolant that has not been jetted from the coolant supply holes 82 is connected to another end of the coolant supply pipe 8 and is returned to the non-illustrated coolant supply system, which is installed outside of the axial gap motor 1, through the coolant. supply pipe outlet 84 provided on a side surface of the end bracket 62.

The coolant that has cooled the stator 2 reaches an inner wall of the housing 61, flows, and is discharged outside of the housing 61 of the axial gap motor 1 from the coolant discharge port 9 provided at the bottom of the housing 61. The coolant that has been discharged from the axial gap motor 1 is returned to the coolant supply system and is supplied again to the axial gap motor 1 through the coolant supply pipe 8 to perform cooling.

The axial gap motor 1 of this embodiment is cooled since the coolant is appropriately supplied to a place to be cooled of the stator 2 as described below, whereby it is possible to be mounted, for example, on a hybrid vehicle and a motor vehicle.

Since the coolant jetted from the coolant supply pipe 8 is extended across a side surface of the rotor 3 in the radial direction to a vicinity of the stator 2, it reaches a desired place of the coil 21 and the core 22 without being influenced by the airflow generated by rotation of the rotor 3.

The supplied coolant flows by the coil 21, the core 22, and the support member 23 supporting the core 22. Subsequently, a part of the supplied coolant is dropped on the shaft 4 and performs the cooling of the shaft 4. Furthermore, the coolant is transported. to another portion of the stator 2 due to rotation of the shaft 4 and cools the other portion of the stator 2. The other part of the coolant is supplied to the other portion of the stator 2 through the coil 21 and cools the other portion of the stator 2. In this way, the coolant is supplied to a desired place, whereby cooling is performed appropriately.

In this example, it is not always necessary that a sectional shape of the coolant supply pipe 81 be a trapezoid as long as it has a closed sectional shape capable of transporting the coolant.

### Second Example

FIG. 5 is another sectional view of a coolant supply pipe according to this example. In the example, a sectional shape of the coolant supply pipe 8 is a rectangular shape, and a coolant supply hole 82 is opened on a surface facing a stator 2. In this way, it is possible to directly supply coolant to a part of a coil 21 on an outer periphery side not in contact with a core 22 of the coil 21 as well as to an outer periphery side of a support member 23, whereby the coolant can perform cooling.

In this example, it is possible to open the coolant supply hole 82 on a flat surface of the coolant supply pipe 81, whereby it is easy to be worked in a processing of the coolant supply hole 82.

That is claimed is:

1. An axial gap motor comprising:
a rotor fixed to a rotary shaft;
a stator facing the rotor along a shaft direction;
a flow passage forming body configured to form a flow passage through which a cooling refrigerant is flowed; and
a housing configured to house the rotor and the stator and to hold the flow passage forming body; wherein the flow passage forming body forms
an inflow port provided on a first surface of the housing facing the shaft direction,
a flow passage portion passing from the inflow port through a lateral portion of the rotor in a radial direction, and
a discharge port connected to the flow passage portion and provided closer to the stator than the rotor in the shaft direction.

2. The axial, gap motor according to claim 1, wherein
the discharge port generates jetting force in the shaft direction and jetting force in a direction vertical to the shaft direction.

3. The axial gap motor according to claim 1, wherein.
a sectional shape of the flow passage forming body is a rectangular shape, and
a coolant supply hole is opened on a surface of the flow passage forming body facing the stator.

4. The axial gap motor according to claim 1, wherein
the rotor further includes a first rotor and a second rotor arranged. facing the shaft direction and sandwiching the stator,
the stator further includes:
a core;
a support member supporting the core;
a first coil arranged on a lateral side of the support member on a side close to the first rotor relative to the shaft direction; and
a second coil arranged on a lateral side of the support member on a side close to the second rotor relative to the shaft direction,
the flow passage portion further includes:
a first flow passage portion passing through a lateral portion of the first rotor in a radial direction; and
a second flow passage portion passing through a lateral portion of the second rotor in a radial direction and
the discharge port further includes:
a first discharge port connected to the first flow passage portion and provided closer to the first coil than the first rotor in the shaft direction; and
a second discharge port connected to the second flow passage portion and provided closer to the second coil than the second rotor in the shaft direction.
